(19) United States
(12) Patent Application Publication
(10) Pub. No.: US 2014/0111953 A1
(43) Pub. Date: Apr. 24, 2014

(54) Electronic Devices With Components Mounted to Touch Sensor Substrates

(71) Applicant: Apple Inc., (US)

(72) Inventors: Stephen R. McClure, San Francisco, CA (US); John Raff, Menlo Park, CA (US); Sean S. Corbin, San Jose, CA (US)

(73) Assignee: Apple Inc., Cupertino, CA (US)

(21) Appl. No.: 13/655,982

(22) Filed: Oct. 19, 2012

(51) Int. Cl. G06F 3/044

(52) U.S. Cl. CPC G06F 3/044
USPC 361/749

(57) ABSTRACT

Touch panel structures may be provided with flexible substrates. A touch sensor array may be formed from transparent capacitive touch sensor electrodes. Electrical components such as ambient light sensors, proximity sensors, magnetic sensors, camera sensors, buttons, and integrated circuits may be mounted on the same flexible substrate as the transparent capacitive touch sensor electrodes. A flexible substrate for a touch panel structure may be formed from multiple substrate portions that are coupled using solder connections or conductive adhesive connections. A touch panel may have a flexible tail that is coupled to a printed circuit board in an electronic device housing. The flexible tail may bend when installing the touch panel in the housing.

### BACKGROUND

This relates generally to electronic devices and, more particularly, to electronic devices that contain components such as touch sensors formed from structures on flexible substrates.

Electronic devices often include touch screen displays. For example, a touch screen may be mounted to the front of a housing for a cellular telephone or tablet computer. Assembly operations for an electronic device such as a cellular telephone or tablet device typically involve attaching a touch panel substrate to the inner surface of a display cover glass layer. The touch panel has a substrate with a flexible tail that is attached to a printed circuit board in a main housing a connector. Other components such as cameras and other sensors, audio components, and display module structures also be mounted on substrates with flexible tails that are attached to the printed circuit board in the main housing. The flexible tails that are associated with the touch panel and other components bend to accommodate movement between the display cover glass layer and the housing.

Management of flexible substrates and the tail portions of these substrates can be challenging during assembly and when rework or repair of a device is required. If insufficient length is provided in a flexible tail, the flexible tail or the components attached to the flexible tail may become damaged during assembly. If a tail is too long, the tail may consume more volume within a device than is desired or may strike internal components. The use of numerous flexible substrates can also add undesired complexity to device assembly operations.

It would therefore be desirable to be able to provide improved arrangements for mounting and interconnecting components in electronic devices using flexible substrates.

### SUMMARY

Structures such as touch panels may be formed from flexible substrates. A capacitive touch sensor array may be formed from transparent capacitive electrodes such as electrodes formed from indium tin oxide. Electrical components such as ambient light sensors, proximity sensors, magnetic sensors, camera sensors, buttons, and integrated circuits may be mounted on the same flexible substrate as the transparent conductive capacitive electrodes.

A flexible substrate for a touch panel structure may be formed from multiple substrate portions that are coupled together using solder connections or conductive adhesive connections. A central touch sensor array portion of the substrate may have a rectangular shape. Capacitive electrodes may be formed on the touch sensor array portion. A peripheral flexible printed circuit portion that is coupled to the central touch sensor array portion may have a shape such as an L-shape, C-shape, or O-shape (as examples).

A touch panel may have a flexible tail that is coupled to a printed circuit board in an electronic device housing. The flexible tail bends when installing the touch panel in the housing.

Antenna structures such as metal antenna resonating element structures can be formed on the flexible substrate. A transmission line structure may couple the antenna structures to a radio-frequency transceiver integrated circuit on the flexible substrate.

Further features, their nature and various advantages will be more apparent from the accompanying drawings and the following detailed description of the preferred embodiments.

### BRIEF DESCRIPTION OF THE DRAWINGS

FIG. 1 is a perspective view of an illustrative electronic device with a flexible substrate such as a touch panel substrate on which components are mounted in accordance with an embodiment.

FIG. 2 is a schematic diagram of an illustrative electronic device such as the device of FIG. 1 in accordance with an embodiment.

FIG. 3 is a cross-sectional side view of an illustrative electronic device with a flexible substrate such as a touch panel substrate on which components are mounted in accordance with an embodiment.

FIG. 4 is a top view of an illustrative touch panel substrate on which electrical components have been mounted in accordance with an embodiment.

FIG. 5 is top view of an illustrative touch panel substrate coupled to a flexible printed circuit on which components have been mounted in accordance with an embodiment.

FIG. 6 is a cross-sectional side view of an illustrative pair of substrates having metal traces that are being coupled to each other using hot bar solder connections in accordance with an embodiment.

FIG. 7 is a diagram of an illustrative pair of substrates having metal traces that are being coupled to each other using anisotropic conductive adhesive in accordance with an embodiment.

FIG. 8 is a top view of an illustrative display having a touch sensor array coupled to a flexible printed circuit on which components such as sensors and a camera have been mounted in accordance with an embodiment.

FIG. 9 is a top view of an illustrative display having a touch sensor array coupled to a flexible printed circuit on which components such as integrated circuits and other components have been mounted in accordance with an embodiment.

FIG. 10 is a top view of an illustrative display having a touch sensor array and flexible substrate portions on which antenna structures and radio-frequency transceiver circuits have been mounted in accordance with an embodiment.

FIG. 11 is a cross-sectional side view of an illustrative electronic device showing how a display cover layer with a touch panel may be mounted in a device housing in accordance with an embodiment.

FIG. 12 is a flow chart of illustrative steps involved in forming a device having a touch panel on which electrical components have been mounted in accordance with an embodiment.

FIG. 13 is a flow chart of illustrative steps involved in forming a device having a touch panel coupled to a flexible printed circuit on which components have been mounted in accordance with an embodiment.

### DETAILED DESCRIPTION

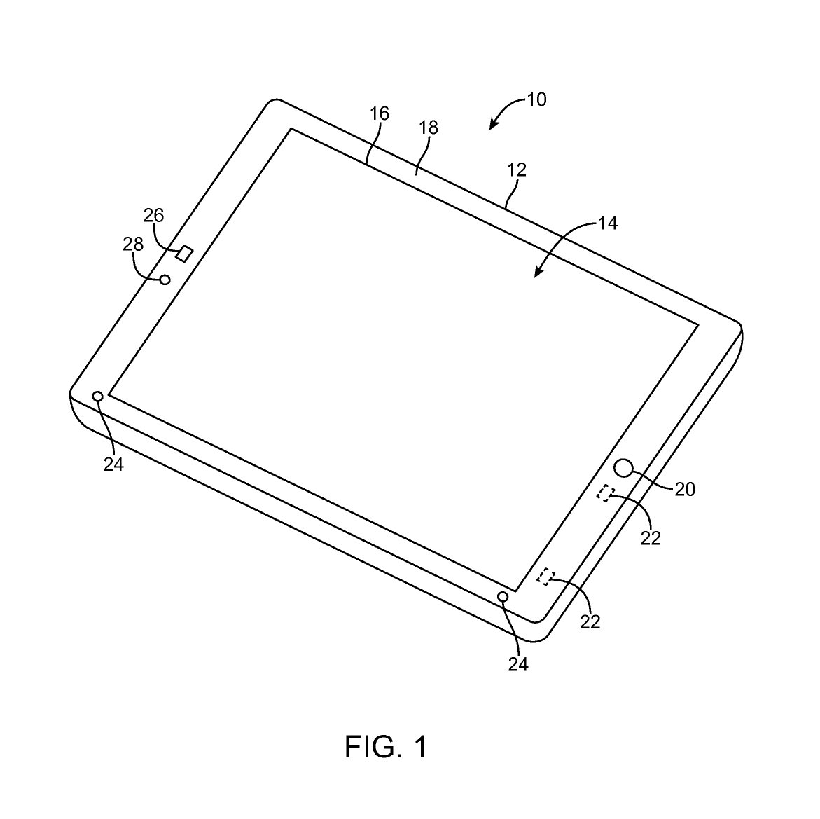

An illustrative electronic device that contains components such as touch sensor panels that are formed from flexible substrates and that contains components mounted to flexible substrates such as touch sensor substrates is shown in FIG. 1. Electronic device 10 of FIG. 1 has the shape of a handheld device or other portable device such as a cellular telephone, tablet computer, media player, or gaming device. In general, electronic device 10 may be a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

Housing 12 of device 10, which is sometimes referred to as a case, is formed of materials such as plastic, glass, ceramics, carbon-fiber composites and other fiber-based composites, metal (e.g., machined aluminum, stainless steel, or other metals), other materials, or a combination of these materials. Device 10 may be formed using a unibody construction in which most or all of housing 12 is formed from a single structural element (e.g., a piece of machined metal or a piece of molded plastic) or may be formed from multiple housing structures (e.g., outer housing structures that have been mounted to internal frame elements or other internal housing structures).

In the illustrative configuration of device 10 that is shown in FIG. 1, device 10 has opposing front and rear surfaces. Housing 12 covers the planar rear surface. Display 14 is mounted on the front surface. Display 14 may have an exterior cover layer that includes openings for components such as button 20. Display 14 is a touch sensitive display that includes a touch sensor. The touch sensor for display 14, which is sometimes referred to as a touch sensor array or touch panel, is formed from an array of capacitive touch sensor electrodes. If desired, the touch sensor may be formed from a resistive touch array, touch sensor structures based on acoustic touch, an optical touch array, force-based touch technologies, or other suitable touch sensor components.

Display 14 for device 10 includes display pixels formed from liquid crystal display (LCD) components or other suitable display pixel structures such as organic light-emitting diode structures, plasma display structures, electrowetting display structures, or electrophoretic display structures.

A display cover layer may cover the surface of display 14 or a display layer such as a color filter layer or other portion of a display may be used as the outermost (or nearly outermost) layer in display 14. The outermost display layer may be formed from a transparent glass sheet, a clear plastic layer, or other transparent member.

Display 14 has an active central region such as rectangular active region 16. Active region 16 contains a rectangular array of display pixels arranged in rows and columns. Active region 16 also contains touch sensor electrodes such as capacitive touch sensor electrodes formed from a transparent conductive material such as indium tin oxide.

Inactive display regions such as region 18 surround active region 16. In the configuration of FIG. 1, peripheral inactive region 18 has the shape of a rectangular ring that serves as a border for display 14. Inactive border region 18 is devoid of display pixels and therefore does not produce image content for a user. Touch sensor structures such as indium tin oxide electrodes are also absent from peripheral portions of display 14 such as inactive region 18.

The underside of the display cover layer in inactive border region 18 is covered with an opaque masking material such as a black polymer (sometimes referred to as black ink). The opaque masking material may hide internal device components from view from the exterior of device 10. Sensors and other components are mounted under the opaque masking material in inactive border region 18.

In the configuration of FIG. 1, for example, device 10 has a camera such as camera 26. Camera 26 has lenses that focus image light onto a digital image sensor. Camera 26 is mounted under an opening (sometimes referred to as a camera window) in the opaque masking material in inactive display region 18. If desired, a camera such as camera 26 may be mounted on the rear of device 10 (e.g., to form a rear-facing camera). The illustrative arrangement of FIG. 1 in which camera 26 is mounted in a front-facing configuration is merely illustrative.

Device 10 also has sensors such as sensors 24, 22, and 28. Sensor 28 is a proximity sensor that monitors for the presence of nearby objects such as parts of a user's body. Proximity sensor 28 preferably has a light source such as an infrared light-emitting diode and a light detector such as a silicon photodetector. The amount of infrared light that is reflected from nearby objects may be measured using the photodetector to produce a proximity sensor signal.

Sensors 24 are ambient light sensors. In general, device 10 may have any suitable number of ambient light sensors (e.g., none, one or more, two or more, three or more, etc.). Each ambient light sensor may contain a photodetector that measures how much light is being received by device 10. Screen brightness adjustments are made to display 14 based on ambient light readings. As an example, the brightness of display 14 is increased when increased ambient light levels are detected and is decreased when decreased ambient light levels are detected.

Sensors 22 are magnetic sensors such as Hall effect sensors. A hinged cover is used to protect device 10 during use. The hinged cover has magnets. When the cover is open, the magnets are far from sensors 22, so device 10 can conclude that the cover is in its open state. When the cover is closed, the magnets in the cover are close to sensors 22. Sensors 22 are therefore able to detect that the magnets are present and that the cover is in its closed position.

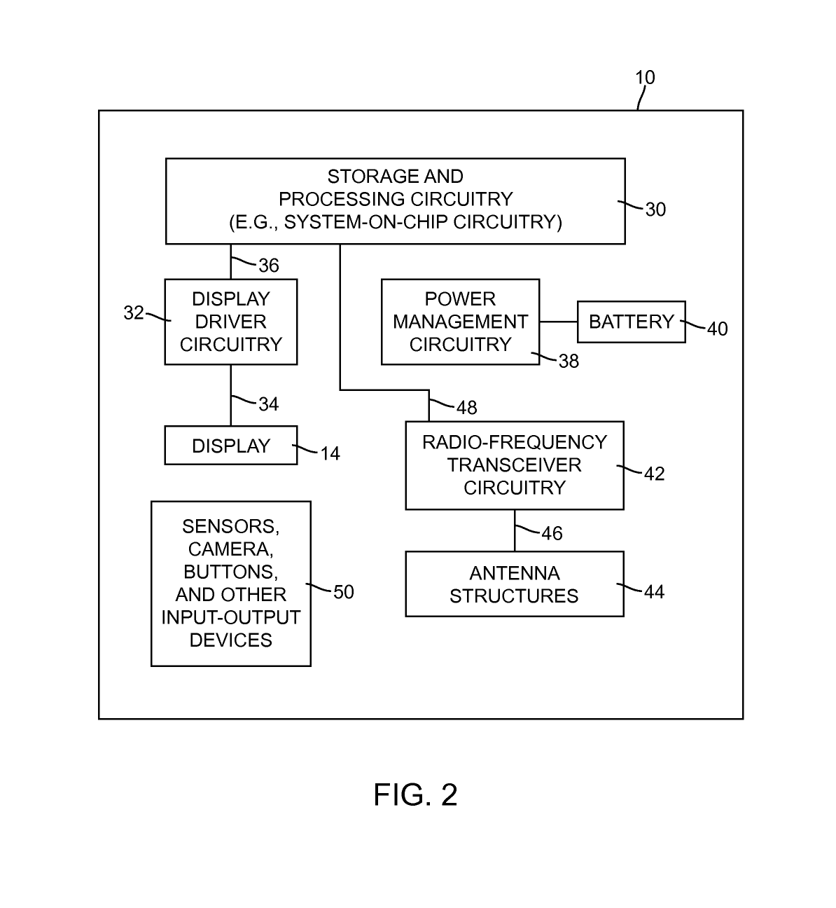

FIG. 2 is a schematic diagram of a device such as device 10 of FIG. 1. As shown in FIG. 2, electronic device 10 includes control circuitry such as storage and processing circuitry 30. Storage and processing circuitry 30 includes one or more different types of storage such as hard disk drive storage, nonvolatile memory (e.g., flash memory or other electrically-programmable-read-only memory), volatile memory (e.g., static or dynamic random-access-memory), etc. Processing circuitry in storage and processing circuitry 30 is used in controlling the operation of device 10. The processing circuitry may be based on a processor such as a microprocessor, a system-on-chip integrated circuit, and other integrated circuits.

With one suitable arrangement, storage and processing circuitry 30 is used to run software on device 10 such as internet browsing applications, email applications, media playback applications, operating system functions, software for capturing and processing images, software for implementing functions associated with gathering and processing sensor data, etc.

Display driver circuitry 32 includes circuitry for receiving and processing image data from storage and processing circuitry 30. Display driver circuitry 32 and storage and processing circuitry 30 communicate using paths such as path 36. Display driver circuitry 32 includes circuitry such as one or more integrated circuits that display corresponding images on display 14 using paths such as path 34.

Power management circuitry 38 includes circuitry for receiving direct current (DC) and/or alternating current (AC) power from an external source and for charging battery 40. Power management circuitry 38 also includes voltage regulator circuitry for producing a regulated direct current output voltage that powers device 10 from battery power or power from the external source.

Radio-frequency (RF) transceiver circuitry 42 includes one or more transceiver integrated circuits, power amplifier circuitry, low-noise input amplifiers, passive radio-frequency components, and other circuitry for handling radio-frequency signals. Radio-frequency transceiver circuitry 42 is coupled to storage and processing circuitry 30 by paths such as path 48. Radio-frequency transceiver circuitry 42 is coupled to antenna structures 44 by transmission line paths such as transmission line 46.

Antenna structures 44 include one or more antennas. Antenna structures 44 can be mounted along edge portions of device housing 12 or in other portions of device 10. Antenna window structures such as windows formed from plastic or other dielectric materials may be used to cover antenna structures in device housing 12 (e.g., in configurations in which device housing 12 is formed from metal) and/or device housing 12 may be formed from plastic or other dielectric that is transparent to radio-frequency signals (e.g., antenna structures 44 may be mounted under dielectric housing structures that form part of the main housing for device 10 and/or may be mounted under separate dielectric windows formed in a metal housing).

The antennas in antenna structures 44 include one or more antennas such as loop antennas, inverted-F antennas, strip antennas, planar inverted-F antennas, slot antennas, cavity antennas, hybrid antennas that include antenna structures of more than one type, or other suitable antennas. As an example, antenna structures 44 can include one or more antennas formed on flexible printed circuit substrates. With this type of configuration, metal traces on a flexible printed circuit substrate such as a layer of flexible polymer are patterned to form inverted-F antenna resonating elements or antenna resonating elements of other types.

The antennas in antenna structures 44 and radio-frequency transceiver circuitry 42 are preferably configured to cover wireless communications bands such as cellular network communications bands, wireless local area network communications bands (e.g., the 2.4 and 5 GHz bands associated with protocols such as the Bluetooth® and IEEE 802.11 protocols), and other communications bands. The antennas in antenna structures 44 support single band and/or multiband operation. For example, the antennas may be dual band antennas that cover the 2.4 and 5 GHz bands, cellular telephone antennas that cover one or more bands at frequencies between 700 MHz and 2.7 GHz or other frequencies of interest, and/or satellite navigation system antennas that cover one or more frequencies. The antennas may also cover more than two bands (e.g., by covering three or more bands or by covering four or more bands).

Conductive structures for the antennas may, if desired, be formed from conductive electronic device structures such as conductive housing structures, from conductive structures such as metal traces on plastic carriers, from metal traces in flexible printed circuits and rigid printed circuits, from metal foil supported by dielectric carrier structures, from wires, and from other conductive materials.

During wireless operation of device 10, storage and processing circuitry 30 provides data to be wirelessly transmitted over path 48. Radio-frequency transceiver circuitry 42 receives the data from storage and processing circuitry 30 and wirelessly transmits corresponding radio-frequency signals through antenna structures 44. Radio-frequency transceiver circuitry 42 includes receiver circuitry that receives radio-frequency signals using antenna structures 44 and provides corresponding received data signals to storage and processing circuitry 30 via path 48.

Device 10 also includes input-output circuitry 50. Input-output circuitry 50 is used to allow data to be supplied to device 10 and to allow data to be provided from device 10 to external devices. Input-output circuitry 50 of FIG. 2 includes input-output devices such as buttons, joysticks, click wheels, scrolling wheels, touch sensors such as track pads or touch-sensor-based buttons or linear sliders, vibrators, audio components such as microphones and speakers, image capture devices such as a camera module having an image sensor and a corresponding lens system, keyboards, status-indicator lights, tone generators, key pads, and other equipment for gathering input from a user or other external source and/or generating output for a user.

Input-output circuitry 50 includes one or more ambient light sensors for gathering information on ambient light levels. The ambient light sensor structures of circuitry 50 include one or more semiconductor detectors (e.g., silicon-based detectors) or other light detection circuitry. Sensors in circuitry 50 also include proximity sensor components. The proximity sensor components may include a dedicated proximity sensor and/or a proximity sensor formed from touch sensors (e.g., a portion of the capacitive touch sensor electrodes in a touch sensor array for display 14 that are otherwise used in gathering touch input for device 10). Proximity sensor components in device 10 can include capacitive proximity sensor components, infrared-light-based proximity sensor components, proximity sensor components based on acoustic signaling schemes, or other proximity sensor equipment. Sensors in circuitry 50 may also include a pressure sensor, a temperature sensor, an accelerometer, a gyroscope, one or more magnetic sensors such as Hall effect magnetic sensors, and other circuitry for making measurements of the environment surrounding device 10.

It can be challenging to mount electrical components such as the components of FIG. 2 within an electronic device. To facilitate mounting of components in housing 12 of device 10, components may be mounted on a flexible substrate such as a flexible printed circuit formed from a sheet of polymer. The flexible substrate may be coupled to a touch panel structure using hot bar solder connections or conductive adhesive connections such as connections formed using anisotropic conductive film (ACF) or the flexible substrate may be formed as an integral portion of a touch panel structure.

A flexible substrate for a flexible printed circuit or flexible touch panel may be provided with conductive traces such as one or more layers of patterned metal traces and/or one or more layers of transparent conductive material such as indium tin oxide. As an example, capacitive touch sensor electrodes can be formed from patterned indium tin oxide on one or more opposing surfaces of a flexible substrate and conductive traces for interconnect lines, contact pads, and other structures may be formed from indium tin oxide or metal. Indium tin oxide electrodes or other capacitive touch sensor electrodes formed on a flexible substrate can form a touch sensor array (sometimes referred to as a touch sensor or touch sensor panel). Electrical components such as integrated circuits and other components can be mounted to contact pads on the same substrate (or a substrate that is coupled to the substrate containing the touch sensor electrodes).

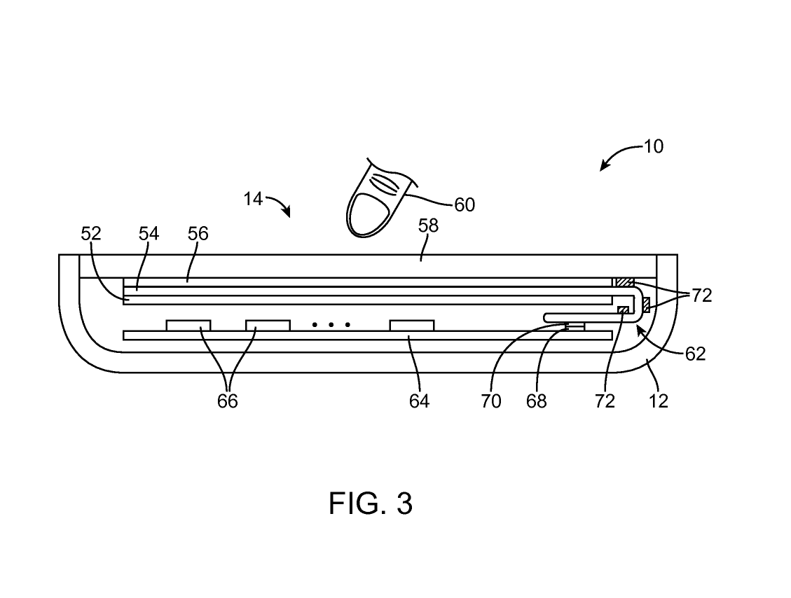

A cross-sectional side view of electronic device 10 in a configuration in which a display touch panel has been provided with an integral portion on which one or more electrical components have been mounted is shown in FIG. 3. As shown in FIG. 3, device 10 has a housing such as housing 12. Housing 12 is preferably formed from metal, glass, ceramic, plastic, fiber-based composites, other materials, or combinations of these materials.

Display 14 is mounted within housing 12. Display 14 is preferably a liquid crystal display, an organic light-emitting diode display, a plasma display, an electrowetting display, an electrophoretic display, or a display formed using other display technologies. Display 14 is formed from one or more substrate layers (e.g., one or more rigid substrate layers such as glass substrate layers and/or one or more flexible substrate layers such as one or more polymer layers). Examples of layers that are included in display 14 include polarizer layers, thin-film-transistor layers, color filter layers, and layers of liquid crystal material. In the example of FIG. 3, these display layers are formed in display module 52. Display module 52 preferably includes structures for forming a liquid crystal display, an organic light-emitting diode display, an electrophoretic display, an electrowetting display, or a display based on other display structures.

Display module 52 is mounted underneath touch sensor panel 54. A layer of adhesive such as adhesive 56 is used to attach touch sensor panel 54 to the underside of display cover layer. Adhesive may also be formed between layers such as touch panel layer 54 and display module 52, if desired.

As shown in FIG. 3, display cover layer 58 is used to form a protective cover for display 14. Display cover layer 58 is formed from a planar transparent member such as a structure formed from glass, plastic, or other transparent material. Touch sensor panel 54 is mounted between display module 52 and display cover layer 58 using a layer of adhesive such as adhesive 56, so that touch input can be detected (e.g., so that panel 54 can sense events when a user's finger such as finger 60 or other external object is placed in the vicinity of touch sensor panel 54).

If desired, touch sensors such as panel 54 may be mounted in housing 12 of device 10 using other arrangements. For example, touch sensor 54 may be attached to the upper surface of display structures 52 or may be incorporated into the layers of material that make up display structures 52. Touch sensors such as touch sensor 54 may also be incorporated into non-display components such as track pads or other input devices.

The touch sensor elements that form touch sensor panel 54 may be based on any suitable touch sensor technology such as acoustic touch technology, force-sensor-based touch technology, resistive touch technology, or capacitive touch technology (as examples). In capacitive touch sensors, capacitive electrodes may be formed from a conductive material. For example, for use in display applications in which the touch sensor electrodes are transparent to allow a user to view an underlying display, the touch sensor electrodes may be formed from a transparent conductive material such as indium tin oxide. Configurations in which touch sensor 54 is a capacitive touch sensor and in which touch sensor electrodes for touch sensor 54 are formed from transparent conductive materials are sometimes described herein as an example. Other types of arrangements may be used for touch sensor 54, if desired (e.g., arrangements with non-capacitive sensors, arrangements with capacitive electrodes formed from materials other than indium tin oxide, etc.).

When used in a display such as display 14 of FIG. 3, the capacitive electrodes of touch sensor 54 are preferably formed on a transparent substrate such as a rectangular clear flexible plastic substrate (e.g., a sheet of polymer). As shown in FIG. 3, the substrate for touch sensor 54 of FIG. 3 has an integral portion such as portion 62 that protrudes outward from the edges of the main portion of the touch sensor substrate. Portion 62 can be a flexible tail portion or other extending or protruding portion of touch sensor 54. Portion 62 preferably includes a signal bus for routing signals between touch panel 54 and circuitry 66 on printed circuit board 64. Circuitry 66 preferably includes one or more integrated circuits or other components (e.g., circuitry 66 of FIG. 3 may form some or all of control circuitry 30 and the other circuitry of FIG. 3). Printed circuit board structures 64 include one or more rigid printed circuit boards and one or more flexible printed circuits.

Connectors or other coupling configurations are used to couple circuitry 66 and circuitry associated with touch sensor 54. As shown in the FIG. 3 example, a connector such as illustrative board-to-board connector 68 is mounted on printed circuit 64 and mating board-to-board connector 70 is mounted on portion 62 of touch panel 54.

Electrical components 72 are mounted to that same substrate that is used in forming touch sensor panel 52. In the illustrative configuration of FIG. 3, electrical components 72 are mounted on opposing upper and lower surfaces of touch sensor panel substrate 52. Conductive traces such as metal traces are coupled to each mounted component. Solder or conductive adhesive is used to couple each component to the metal traces. For example, the metal traces may be configured to form solder pads to which components 72 are mounted using solder. Components 72 include components such as integrated circuits and other circuits, connectors (e.g., board-to-board connectors, zero insertion force connectors, etc.), sensors such as ambient light sensors, proximity sensors, and magnetic sensors, mechanical buttons (e.g., buttons based on dome switches), capacitive sensor buttons or sliders (e.g., to form a menu button or volume button), cameras, processing circuits, power management circuits, display driver integrated circuits, radio-frequency transceiver circuits, antenna structures, etc.

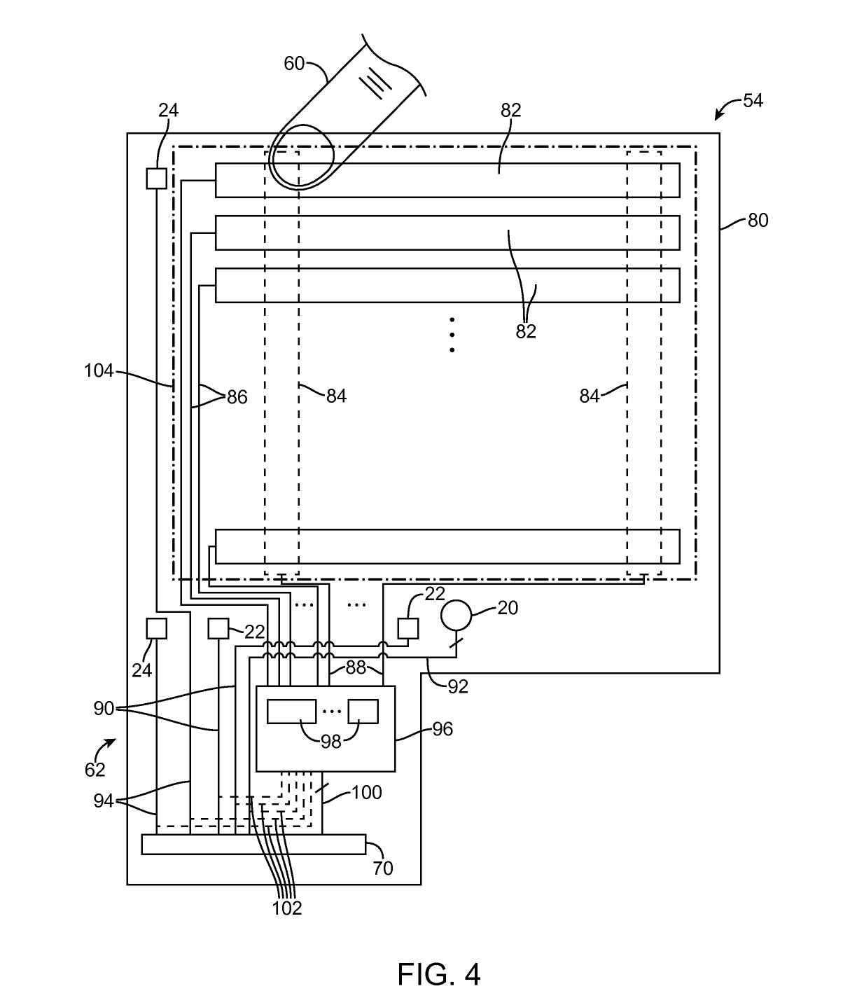

FIG. 4 is a top view of an illustrative touch panel sensor. As shown in FIG. 4, touch panel sensor 54 has a dielectric substrate such as dielectric substrate 80. Substrate 80 may be a layer of clear flexible polymer. Capacitive touch sensor electrodes such as electrodes 82 and 84 are formed on substrate 80. Electrodes 82 and 84 may be formed on the same side of substrate 80 or may be formed on opposing sides of substrate 80, as shown in FIG. 4. Conductive lines such as lines 86 are used to couple horizontal electrodes 82 to circuitry 96. Conductive lines 88 are used to couple vertical electrodes 84 to circuitry 96. Vias are used to form connections between backside structures such as vertical electrodes 84 and frontside structures on substrate 80.

Electrodes 82 and 84 are patterned to allow the location of touch events (e.g., touch input from finger 60) to be ascertained during operation of device 10. The configuration of FIG. 4 in which electrodes 82 are formed from horizontal strips of indium tin oxide and in which electrodes 84 are formed from vertical strips of indium tin oxide is merely illustrative. Touch sensor array 54 may be formed from electrodes having other array patterns (e.g., patterns of diagonally connected square pads, patterns of interleaved squares and thin vertical lines, etc.).

Substrate 80 has extended portions on which electrical components are mounted such as components 24, components 22, and component 20. In the illustrative configuration of FIG. 4, components 24 are ambient light sensors, components 22 are magnetic sensors such as Hall effect sensors, and component 20 is a dome-switch-based menu button. Other arrangements may be used, if desired. For example, component 20 may be a capacitive-sensor-based button or other input device, components 24 may include proximity sensors, cameras, or other sensors, etc.

Paths such as paths 94 are used to convey signals from ambient light sensors 24 to connector 70. Paths such as paths 90 are used to convey signals from Hall effect sensors 22 to connector 70, and paths such as path 92 are used to convey signals from button 20 to connector 70. Circuitry 96 may be used to form an interface between touch sensor electrodes 82 and 84 and connector 70. Paths 86 may couple circuitry 96 to electrode structures 82. Paths 88 may couple circuitry 96 to electrode structures 84. Path 100 couples circuitry 96 to connector 70. Connector 70 is configured to connect to a mating connector such as connector 68 on printed circuit 64 (FIG. 3). If desired, contact pads on substrate 80 may take the place of connector 70 or may be used in addition to connector 70 (e.g., contact pads for forming solder connections with external structures such as printed circuit 64, contact pads for forming conductive adhesive connections with external structures such as printed circuit 64, etc.).

Circuitry 96 includes one or more circuits such as circuits 98. Circuitry 96 and/or circuits 98 are preferably implemented using integrated circuits. A capacitive touch sensor integrated circuit in circuits 98 may, for example, be used to convert raw capacitance measurements made using electrodes 84 and 82 into touch input data. Circuits 98 preferably include communications circuitry that is used for communicating with circuitry 66 on printed circuit 68 of FIG. 3 (e.g., control circuitry 30 of FIG. 2). The communications circuitry includes circuitry for transmitting and receiving digital data over path 100. An example of a communications protocol that may be implemented using one or more circuits 98 in circuitry 96 is the Universal Serial Bus (USB) protocol. Other types of communications may be supported by circuitry 96, if desired.

By using a communications protocol such as the USB protocol, circuitry 96 can convey touch event data from the touch sensor array formed from electrodes 82 and 84 over relatively few lines (e.g., a serial bus), thereby allowing the number of lines in path 100 to be minimized (e.g., allowing use of a pair of positive and negative data lines as with the USB protocol). As indicated by dashed lines 102, lines 94, 90, and 92 may optionally be coupled to circuitry 96. In this type of scenario, circuitry 96 can be configured to multiplex signals from one or more of components 24, 22, and 20 onto paths such as path 100 (e.g., the same USB path that is used to convey data from touch electrodes 82 and 84 or a parallel USB path). If desired, serial bus paths such as USB path 100 may be implemented using other serial and/or parallel data communications protocols. The use of the Universal Serial Bus protocol is merely illustrative.

In the example of FIG. 4, portion 104 of touch panel 54 forms a touch sensor array (e.g., touch sensor capacitive electrodes 82 and 84 are formed within rectangular central touch sensor array region 104). Components 24, 22, and 20, components such as circuits 98 of circuitry 96, and connector 70 have been mounted on extended portions of substrate 80 that are integral with the portion of substrate 80 that lies within touch sensor array region 104.

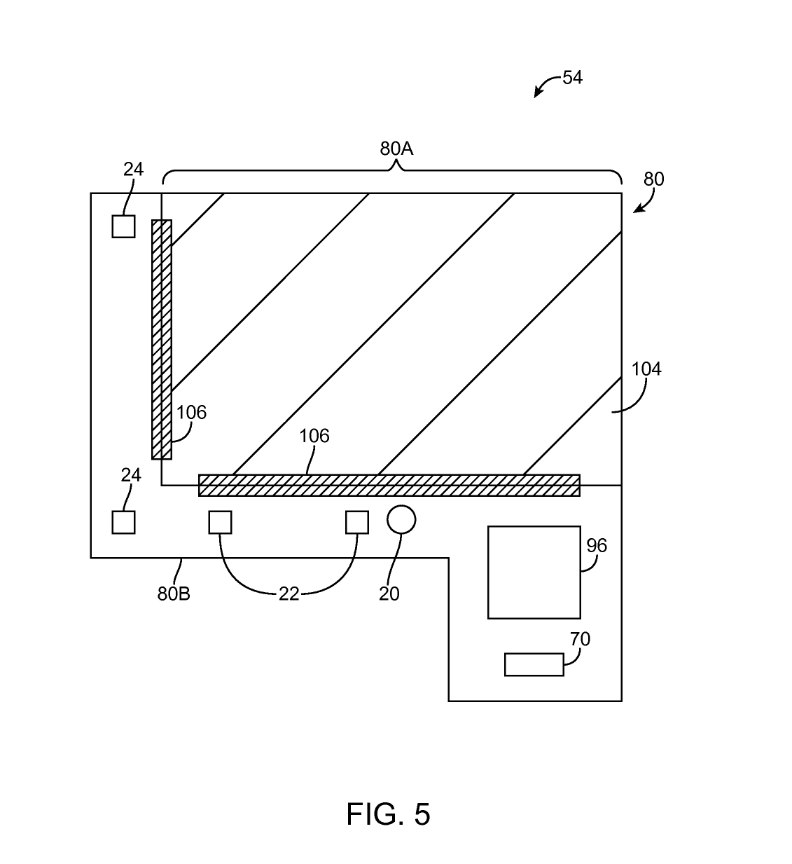

If desired, touch sensor array 104 and the flexible substrate portions to which electrical components 24, 22, 20, circuitry 96, and connector 70 are mounted may be formed from two or more individual flexible substrates. In the illustrative configuration of FIG. 5, for example, touch sensor panel 54 has been formed from a flexible substrate such as substrate 80 that has first and second coupled portions such as portions 80A and 80B. Portion 80A is a rectangular touch sensor array substrate covering touch sensor array area 104. Capacitive touch sensor electrodes are formed on portion 80A of substrate 80, such as indium tin oxide electrodes 82 and 84.

Portion 80B has an L shape and is formed from a separate piece of flexible substrate material. Electrical components such as ambient light sensors 24, magnetic sensors 22, button 20, circuitry 96, and connector 70 are formed on extension portion 80B of flexible dielectric substrate 80. Electrical connections between substrate portion 80B and substrate portion 80A are formed in locations such as locations 106 of FIG. 5.

If desired, substrate portion 80B may have other shapes. For example, substrate portion 80B may have a C shape. In a C-shaped configuration, an upper portion of substrate portion 80B runs along the upper edge of region 104, an edge portion of substrate portion 80B runs along the side of region 104, and a lower portion of substrate 80B runs along the lower edge of substrate portion 80A. Substrate portion 80B may also be implemented using a single strip of substrate material such as a single flexible printed circuit strip that runs along the upper edge of substrate 80A, a single flexible printed circuit strip that runs along the right or left edge of substrate portion 80A, or a single strip of flexible printed circuit that runs along the lower edge of substrate portion 80A. Electrical connections 106 and/or non-electrical connections such as connections formed from strips of adhesive can be used in coupling substrate portions 80A and 80B together.

A ring shape (O-shape) may also be used for substrate portion 80B. In O-shaped arrangements, substrate portion 80B surrounds substrate portion 80A and electrical connections 106 are formed on one, two, three, or four sides of substrate portion 80A. The edges of substrate portion 80A that are not provided with electrical connections 106 may be provided with adhesive connections or other connections for mechanically securing substrate portion 80A to substrate portion 80B. Three or more, four or more, or five or more substrate portions such as substrate portion 80B may be coupled to touch sensor array substrate portion 80A if desired. The configuration of FIG. 5 in which there are two separate substrate portions that are coupled to form substrate 80 for touch sensor panel 54 is merely illustrative.

Electrical connections 106 of FIG. 5 are formed from contacts on opposing flexible substrate structures. Conductive adhesive such as anisotropic conductive film (ACF), solder, or other conductive materials may be used in electrically connecting respective mating contacts for forming connections 106.

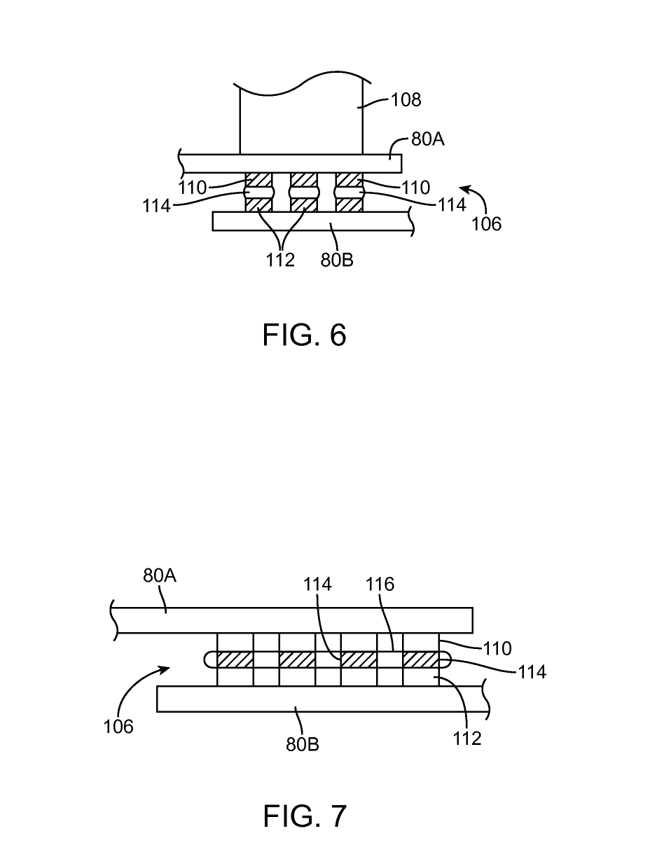

FIG. 6 is a cross-sectional side view of connection 106 in a configuration in which solder joints are being formed. In the example of FIG. 6, substrate portion 80A has been provided with an array of contact pads 110 and substrate portion 80B has been provided with an array of corresponding contact pads 112. Solder connections 114 (e.g., solder balls) are used to form connections between each opposing pair of contacts. Solder paste is applied to the contacts using screen printing or other solder paste patterning techniques. Substrates 80A and 80B are then brought into contact with each other as shown in FIG. 6. Once substrates 80A and 80B and contacts 110 and 112 are adjacent to each other as shown in FIG. 6, hot bar 108 is used to reflow the solder paste to form solder joints 114. Use of hot bar 108 to locally heat the solder helps avoid damage to potentially sensitive components such as electrodes 82 and 84 on substrate portion 80A and helps avoid damage to previously mounted electrical components on substrate portion 80B.

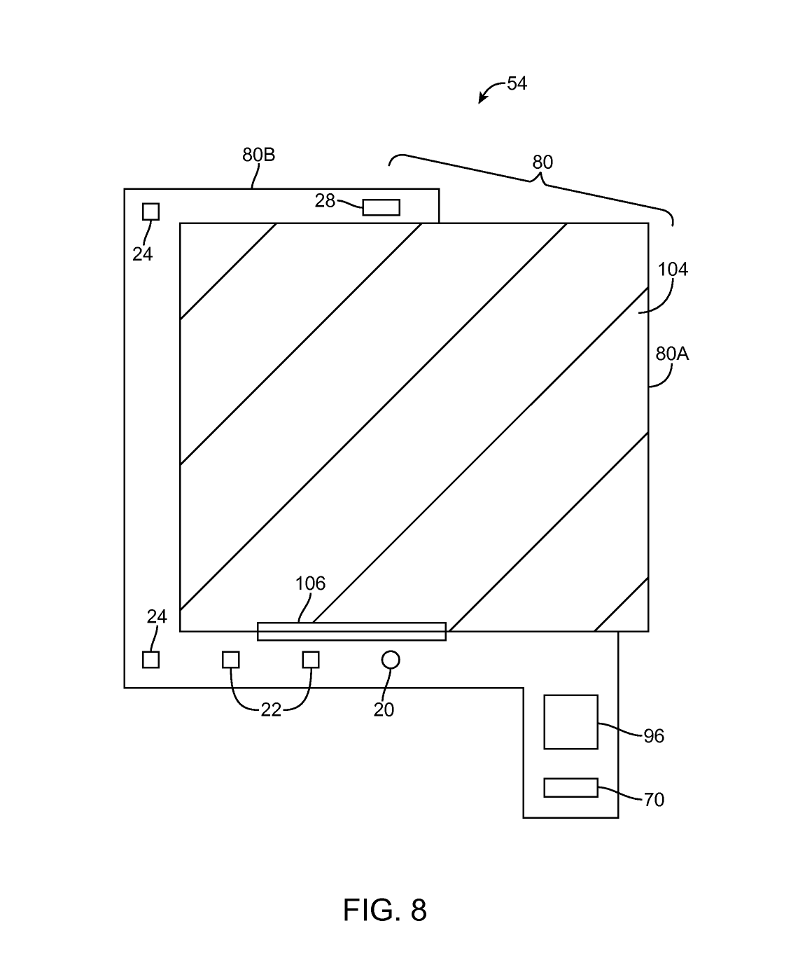

FIG. 7 is a cross-sectional side view of connection 106 in a configuration in which anisotropic conductive film is being used to form electrical pathways between contact pads. In the example of FIG. 7, substrate portion 80A has been provided with an array of contact pads 110 and substrate portion 80B has been provided with a corresponding array of contact pads 112. Anisotropic conductive adhesive 116 (sometimes referred to as anisotropic conductive film or conductive adhesive) has been placed between flexible substrate portions 80A and 80B and between opposing contacts 110 and 112. Adhesive 116 may, if desired, be patterned to form local portions of adhesive 116 between each pair of opposing upper and lower contacts. Following application of heat and pressure to flow and cure the conductive adhesive, conductive connections 114 are formed been contact pads 110 on substrate portion 80A and respective contact pads 112 on substrate portion 80B.

Electrical connections of the type shown in FIGS. 6 and 7 are used to form electrical pathways between segments of conductive lines 86 and conductive lines 88 on substrate portion 80A and mating portions of conductive lines 86 and conductive lines 88 on substrate portion 80B.

In the illustrative configuration for touch sensor panel 54 that is shown in FIG. 8, substrate portion 80B has a C-shape and surrounds the top, bottom, and left edges of substrate portion 80A. Electrical connections of the type shown in FIGS. 6 and 7 are formed along one, two, or three of the edges of substrate portion 80A that are adjacent to substrate portion 80B. In the FIG. 8 example, the uppermost strip of substrate portion 80B has been used to form a flexible printed circuit substrate for camera 28. Camera 28 is preferably a camera module having a camera module housing. A digital image sensor is located in the housing. Lenses in the housing focus image light onto the digital image sensor. The digital image sensor has contact pads that are soldered to corresponding contact pads on flexible printed circuit 80B.

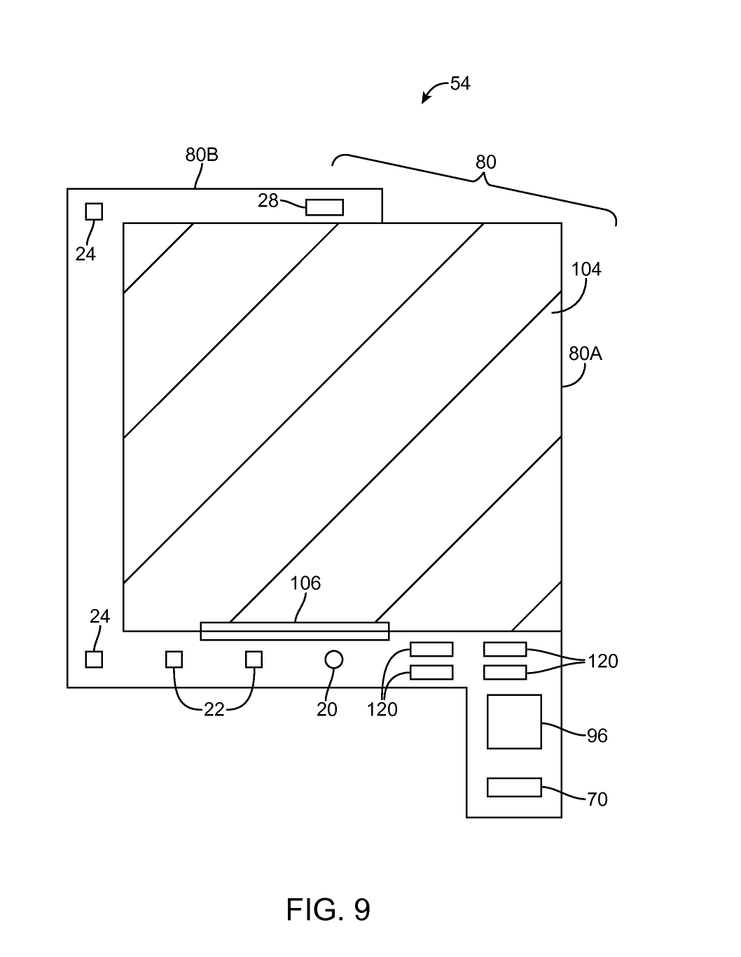

FIG. 9 is a top view of touch sensor panel 54 in a configuration in which additional components 120 have been mounted on flexible printed circuit portion 80B. Components 120 may include one or more components such as one or more display driver integrated circuits 32 (FIG. 2), one or more power management integrated circuits 38 (FIG. 2), one or more radio-frequency transceiver integrated circuits 42 (FIG. 2), one or more control circuits such as system-on-chip integrated circuits, microprocessor integrated circuits, and/or memory integrated circuits (see, e.g., control circuitry 30 of FIG. 2), or other integrated circuits or components.

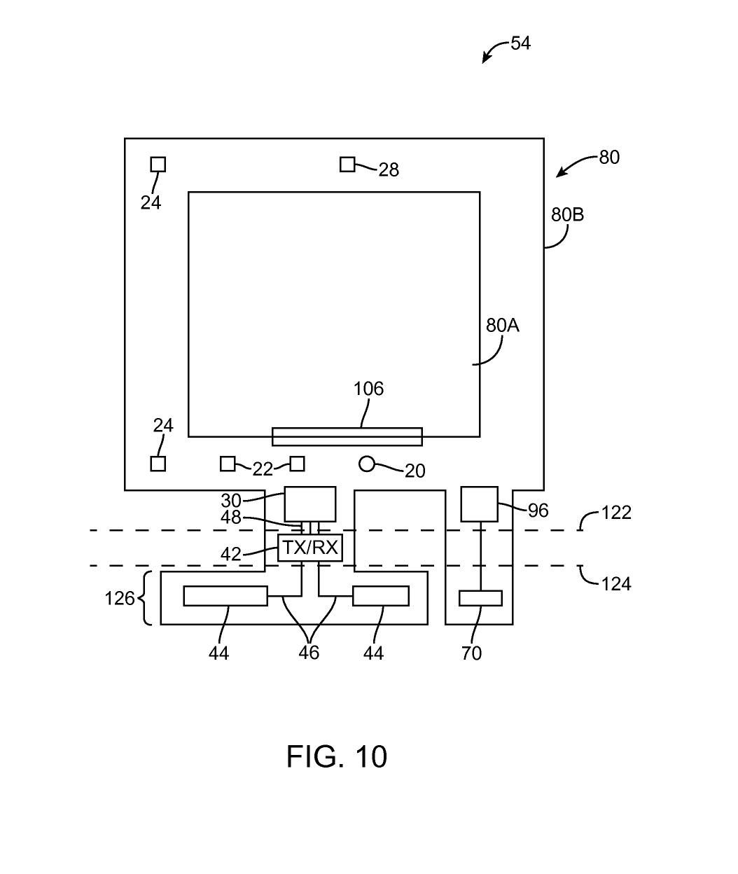

In the illustrative configuration of FIG. 10, substrate 80 has been formed using first substrate portion 80A (e.g., a touch sensor array portion having capacitive electrodes for a touch sensor) and second ring-shaped substrate portion 80B. Portion 126 of substrate portion 80B contains antenna structures 44 (e.g., one or more antenna resonating elements coupled to respective transmission lines 46). The resonating elements in antenna structures 44 are preferably formed from patterned metal traces on flexible printed circuit substrate portion 80B in region 126. Transmission lines 46 couple the antennas to radio-frequency transceiver circuitry 42. Transmission lines 46 may be formed from metal traces (e.g., traces configured to form one or more microstrip transmission line structures or transmission lines of other types). Communications paths 48 couple radio-frequency transceiver 42 to control circuitry 30.

The flexible printed circuit substrate material of portion 80B is bent along a bend axis such as bend axis 124 (thereby bending transmission lines 146) or bend axis 122 (thereby bending data lines 148) when mounting substrate 80 in housing 12 of device 10. If desired, bends may be formed in substrate 80B along both bend axis 122 and bend axis 124. Other portions of substrate 80 may also be bent, if desired.

Although illustrated using separate substrate portions 80A and 80B in the configurations of FIGS. 5, 8, 9, and 10 touch sensor panels 54 of the types shown in FIGS. 5, 8, 9, and 10 may be formed using integral touch sensor substrates of the type shown in FIG. 4, if desired.

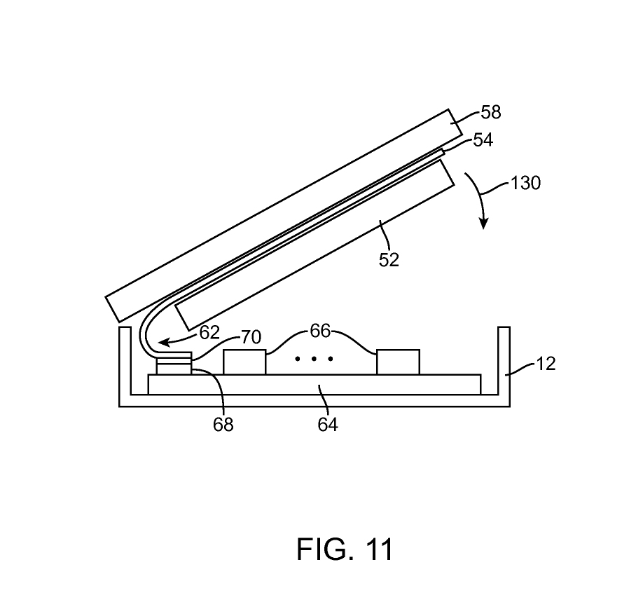

To assemble device 10, display cover layer 58 is rotated in direction 130, as shown in FIG. 11. Rotation operations in direction 130 are preferably performed following attachment of touch sensor panel 54 to display cover layer 58 and attachment of connectors such as connector 70 on flexible printed circuit substrate 80 to connector 68 on printed circuit board 64. Adhesive, fasteners, or other attachment mechanisms are then used to attach display cover layer 58, touch sensor panel 54, and display module 52 to housing 12.

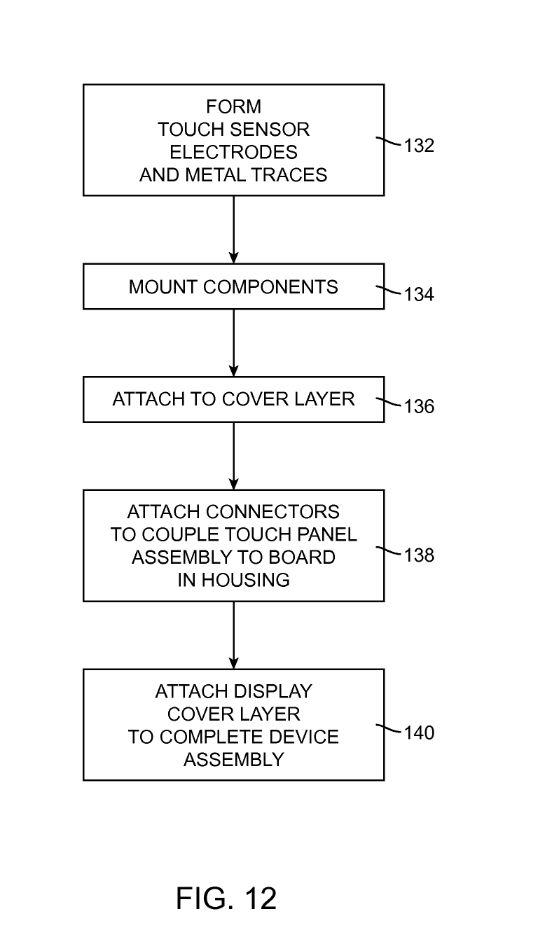

FIG. 12 is a flow chart of illustrative steps involved in forming electronic device 10 using a touch sensor flexible substrate having integral portions on which electrical components are mounted.

At step 132, capacitive touch sensor electrodes 82 and 84 and associated metal traces for lines 94, 90, 92, 86, and 88 are formed on a layer of polymer or other flexible dielectric substrate 80 (e.g., using physical vapor deposition and photolithographic patterning techniques or other suitable fabrication techniques).

At step 134 a pick-and-place tool or other equipment is used to mount electrical components on the same flexible substrate on which the capacitive touch sensor electrodes were formed. If desired, pick-and-place operations may be performed before the deposition and patterning of indium tin oxide layers. During electrical component mounting operations, conductive adhesive, solder, or other conductive materials may be used to form electrical connections between contacts on the electrical components and mating contacts formed from the metal traces on the flexible substrate.

At step 136, touch sensor flexible substrate 80 is attached to a display layer such as display cover layer 58 using adhesive 56.

A board-to-board connector such as connector 70 is attached to a mating connector such as connector 68 of FIG. 11 at step 138. This couples touch sensor panel 54 to circuitry 66 on board 64. Signals associated with the components that are mounted on flexible touch sensor substrate 80 can be conveyed through connector 70 to circuitry 66 (e.g., using a serial bus path such as a USB path and/or other signal paths).

At step 140, display cover layer 58 is rotated into place and attached to housing 12 to complete the assembly of device 10.

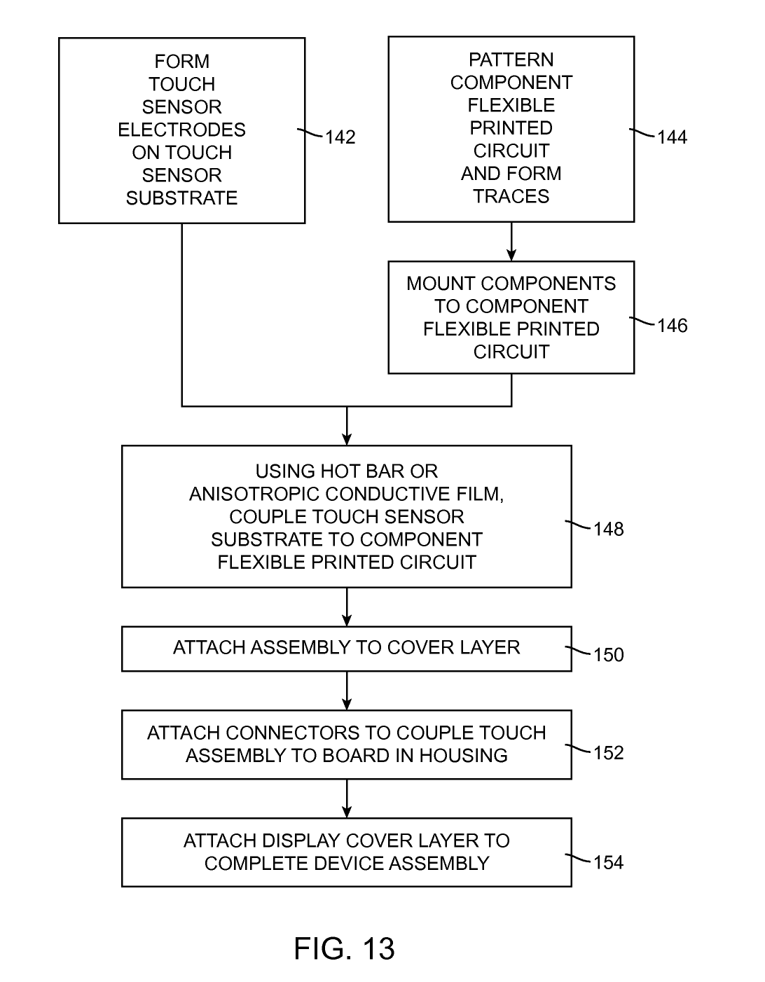

Illustrative steps involved in forming electronic device 10 using a flexible substrate having two or more separate portions that are coupled together are shown in FIG. 13.

At step 142, physical vapor deposition equipment, lithographic patterning tools, and other equipment is used in forming transparent conductive capacitive electrodes 82 and 84 and metal lines on a flexible substrate. If desired, a rigid substrate may be used for the touch sensor substrate. Use of flexible substrate scenarios are described herein as an example.

At step 144, metal traces are patterned on another flexible substrate and the substrate is cut into a desired shape.

At step 146, soldering techniques, conductive adhesive attachment techniques, or other techniques are used to mount electrical components such as ambient light sensors, magnetic sensors, cameras, buttons, capacitive-sensor-based buttons, integrated circuits, and other electrical components onto the flexible substrate formed during the operations of step 144.

At step 148, conductive adhesive or solder is used to electrically couple the touch sensor array substrate from step 142 (substrate portion 80A) and the flexible substrate from step 146 (substrate portion 80B). Hot bar soldering techniques or other techniques may be used in coupling substrate portions 80A and 80B to form unified flexible substrate 80. Connections 106 between traces on substrate portion 80A and 80B allow signals to pass between substrate portions 80A and 80B during operation of the touch sensor and other components.

At step 150, the touch sensor panel formed from substrate portions 80A and 80B is attached to a display layer such as display cover layer 58 using adhesive 56.

A board-to-board connector such as connector 70 is attached to a mating connector such as connector 68 of FIG. 11 at step 152, thereby electrically coupling touch sensor panel 54 to circuitry 66 on board 64. During operation of device 10, signals that are associated with the touch sensor array and electrical components that are mounted on flexible touch sensor substrate 80 can be conveyed through connector 70 to circuitry 66 (e.g., using a serial data path such as a USB path and/or other signal paths).

At step 154, display cover layer 58 is rotated into place and attached to housing 12 to complete the assembly of device 10.

The foregoing is merely illustrative and various modifications can be made by those skilled in the art without departing from the scope and spirit of the described embodiments. The foregoing embodiments may be implemented individually or in any combination.

What is claimed is:

1. Apparatus, comprising:
a flexible polymer substrate;
transparent capacitive touch sensor electrodes on the flexible polymer substrate; and
at least one electrical component mounted on the flexible polymer substrate.

2. The apparatus defined in claim 1 wherein the at least one electrical component comprises an ambient light sensor.

3. The apparatus defined in claim 2 wherein the at least one electrical component comprises a magnetic sensor.

4. The apparatus defined in claim 1 wherein the substrate has four edges and wherein the at least one electrical component comprises two ambient light sensors located along one of the four edges.

5. The apparatus defined in claim 1 wherein the at least one electrical component comprises a button.

6. The apparatus defined in claim 1 wherein the flexible substrate comprises a protruding portion and wherein the at least one electrical component comprises an integrated circuit on the protruding portion.

7. The apparatus defined in claim 6 wherein the protruding portion includes a microprocessor integrated circuit.

8. The apparatus defined in claim 1 wherein the at least one electrical component comprises a display driver integrated circuit on the flexible substrate.

9. The apparatus defined in claim 1 wherein the at least one electrical component comprises a memory integrated circuit on the flexible substrate.

10. The apparatus defined in claim 1 wherein the at least one electrical component comprises a radio-frequency transceiver integrated circuit.

11. The apparatus defined on claim 10 further comprising antenna resonating element metal traces on the flexible substrate.

12. The apparatus defined in claim 11 further comprising a transmission line on the flexible substrate that is coupled between the antenna resonating element metal traces and the radio-frequency transceiver integrated circuit.

13. A touch sensor structure, comprising:
a touch sensor array flexible substrate;
transparent capacitive touch sensor electrodes on the touch sensor array flexible substrate;
a flexible printed circuit substrate;
electrical connection structures that electrically connect traces on the flexible printed circuit substrate to the capacitive touch sensor electrodes on the touch sensor array flexible substrate; and
at least one electrical component mounted on the flexible printed circuit substrate.

14. The touch sensor structure defined in claim 13 wherein the electrical connection structures comprise solder connections.

15. The touch sensor structure defined in claim 13 wherein the electrical connection structures comprise conductive adhesive connections.

16. The touch sensor structure defined in claim 13 wherein the at least one electrical component comprises a touch sensor integrated circuit.

17. The touch sensor structure defined in claim 13 wherein the at least one electrical component comprises a button.

18. The touch sensor structure defined in claim 13 wherein the at least one electrical component comprises an ambient light sensor.

19. The touch sensor structure defined in claim 13 wherein the flexible printed circuit substrate has a C-shape that is attached to the touch sensor array flexible substrate along three edges of the touch sensor array flexible substrate.

20. The touch sensor structure defined in claim 13 wherein the flexible printed circuit substrate has an L-shape that is attached to the touch sensor array flexible substrate along two edges of the touch sensor array flexible substrate.

21. The touch sensor structure defined in claim 13 wherein the flexible printed circuit has a ring shape that surrounds the touch sensor array flexible substrate.

22. The touch sensor structure defined in claim 13 wherein the at least one electrical component comprises a capacitive touch sensor integrated circuit.

23. The touch sensor structure defined in claim 13 wherein the at least one electrical component comprises a button.

24. An electronic device comprising:
a housing;
a display cover layer attached to the housing;
at least one printed circuit board in the housing;
a touch sensor panel having a flexible substrate, wherein the touch sensor panel is electrically coupled to the printed circuit board, wherein at least one electrical component is mounted to the touch sensor panel, wherein the touch sensor panel comprises a plurality of capacitive touch sensor electrodes, and wherein the touch sensor panel is attached to an inner surface of the display cover layer.

25. The electronic device defined in claim 24 wherein the capacitive touch sensor electrodes comprise transparent capacitive touch sensor electrodes and wherein the at least one electrical component comprises a button.

26. The electronic device defined in claim 24 wherein the at least one electrical component comprises a magnetic sensor.

27. The electronic device defined in claim 24 wherein the at least one electrical component comprises an integrated circuit.

28. The electronic device defined in claim 27 further comprising a connector coupled to the integrated circuit by a serial bus path.

29. The electronic device defined in claim 24 further comprising an antenna resonating element on the flexible substrate.
